(19) United States
(12) Patent Application Publication
(10) Pub. No.: US 2025/0315068 A1
(43) Pub. Date: Oct. 9, 2025

(54) HUMIDIFYING DEVICE AND METHOD WITH VAPOR PRESSURE DEFICIT CONTROL

(71) Applicant: AC Infinity Inc., City of Industry, CA (US)

(72) Inventors: Jimmy Liu, Brea, CA (US); Daniel Yu Hsu, Upland, CA (US); Wilbur Y. Cheng, Chino Hills, CA (US); Wei Ying Shao, Alhambra, CA (US)

(21) Appl. No.: 18/627,043

(22) Filed: Apr. 4, 2024

(51) Int. Cl. G05D 22/02; A01G 9/24

(52) U.S. Cl. CPC G05D 22/02; A01G 9/246

(57) ABSTRACT

A humidifying device with VPD control for indoor residential cannabis cultivation is provided. The humidifying device with VPD control for indoor residential cannabis cultivation include: a control module with a processing unit, a display screen and an IO interface; a humidifier for providing moisture in response to a humidifier control signal from the control module; a fan for circulating moisture in response to a fan control signal from the control module; and a temperature-humidity sensor for sensing an environmental temperature value T and an environmental relative humidity value RH within an indoor cannabis cultivation environment, the environmental temperature value T and the environmental relative humidity value RH are transmitted to the control module in real time, and a leaf VPD value is calculated from the environmental temperature value T and the environmental relative humidity value RH by the processing unit of the control module.

### FIELD OF INVENTION

This invention relates to vapor pressure deficit control device and method for indoor plant cultivation, and in particular to vapor pressure deficit control device and method for residential indoor cannabis cultivation to increase cannabis yields.

### BACKGROUND OF INVENTION

Commercial indoor plant growers use temperature and humidity parameters to fine tune their cultivation environment to increase plant yield, but for emerging residential indoor growers, they often lack the tools needed to maintain an optimal growing environment with temperature and humidity. Such tools include for example, humidifier, dehumidifier, air conditioner, and heater.

An object of the invention is to provide an improved and efficient device and method to control the residential indoor cannabis cultivation environment using vapor pressure deficit (“VPD” hereafter.) By utilizing VPD, residential growers can eliminate at least one or two of the above-mentioned expensive equipment's while still maintaining the same optimal cultivation environment as long as the temperature and humidity of the cultivation space does not reach extreme levels. This is because both the heater and the dehumidifier are able to increase VPD, while both the air conditioner and humidifier are able to decrease VPD.

### SUMMARY OF INVENTION

Vapor Pressure Deficit, or VPD, plays a crucial role in plant indoor cultivation, especially high valued plants, such as cannabis. VPD is the difference between moisture that is currently in the air and how much moisture the air can hold at saturation, or dew point under certain conditions.

According to an embodiment of the invention, a humidifying device with VPD control for indoor residential cannabis cultivation is disclosed. The humidifying device with VPD control includes: a control module with a processing unit, a display screen and an IO interface; a humidifier for providing moisture in response to a humidifier control signal from the control module; a fan for circulating moisture in response to a fan control signal from the control module; and a temperature-humidity sensor for sensing an environmental temperature value T and an environmental relative humidity value RH within an indoor cannabis cultivation environment, the environmental temperature value T and the environmental relative humidity value RH are transmitted to the control module in real time, and a leaf VPD value is calculated from the environmental temperature value T and the environmental relative humidity value RH by the processing unit of the control module.

According to an embodiment of the invention, the leaf VPD value is compared with a pre-determined VPD threshold value to determine running modes of the humidifier and the fan to control the leaf VPD value within the indoor cannabis cultivation environment, and the control module transmits the humidifier control signal to the humidifier and the fan control signal to the fan to adjust the environmental temperature value T and the environmental relative humidity value RH within the indoor cannabis cultivation environment.

According to an embodiment of the invention, the temperature-humidity sensor senses an updated environmental temperature value T and an updated environmental relative humidity value RH within the indoor cannabis cultivation environment; the updated environmental temperature value T and the updated environmental relative humidity value RH are transmitted to the control module; and an updated leaf VPD value is calculated from the updated environmental temperature value T and the updated environmental relative humidity value RH by the processing unit of the control module.

According to an embodiment of the invention, the updated leaf VPD value is compared with the pre-determined VPD threshold value again to adjust the running modes of the humidifier and the fan to control the leaf VPD within the indoor cannabis cultivation environment; and the control module transmits the humidifier control signal to the humidifier and the fan control signal to the fan to adjust the environmental temperature value T and the environmental relative humidity value RH within the indoor cannabis cultivation environment.

According to an embodiment of the invention, a humidifying device with VPD control for indoor residential cannabis cultivation, the humidifying device with VPD control includes: a power unit for providing electric power to the humidifying device with VPD control for indoor residential cannabis cultivation; a DC fan driven by a DC motor; a humidifier for providing moisture to the humidifying device with VPD control for indoor residential cannabis cultivation, the humidifier includes a plurality of humidifying power gears under a humidifying mode; an IO interface for input and output of control information and status information; a temperature-humidity sensor for sensing an environmental temperature value T and an environmental relative humidity value RH within an indoor cannabis cultivation environment, wherein a leaf VPD value is calculated from the environmental temperature value T and the environmental relative humidity value RH; and a main control unit for communicating with and controlling the power unit, the DC fan, the DC motor, the humidifier, the IO interface, and the temperature-humidity sensor, wherein, in a VPD humidifying mode of the humidifying device with VPD control, the leaf VPD value calculated from the environmental temperature value T and the environmental relative humidity value RH is implemented to control the humidifying device with VPD control for indoor residential cannabis cultivation.

According to an embodiment of the invention, the leaf VDP is calculated from the environmental temperature value T and the environmental relative humidity value RH by: Leaf VPD=610.78 e\hat{ }(17.2694 (T+Leaf offset)/(237.3+T+Leaf offset))−610.78 e\hat{ }(17.2694 T/(237.3+T))×RH/100, VPD unit is in Pa, T is temperature of the air in degrees Celsius, RH is relative humidity of air in % unit and e≈2.71828.

According to an embodiment of the invention, when the Leaf Offset is defaulted to 0° C., the leaf VPD value is calculated from the environmental temperature value T and the environmental relative humidity value RH via: Leaf VPD=610.78 e\hat{ }(17.2694 T/(237.3+T)) (1−RH/100), Leaf VPD unit is in Pa, T is temperature of the air in degrees Celsius, RH is relative humidity of air in % unit and e≈2.71828. According to an embodiment of the invention, the user can set a Leaf Offset value between −10° C. and 10° C.

According to an embodiment of the invention, in an VPD humidifying mode, when the leaf VPD is greater than or equal to a predetermined threshold VPDs, the humidifying power gear is increased gradually to a Max-level humidifying power gear set in the ON humidifying mode, wherein when the leaf VPD is lower than the predetermined threshold VPDs, the humidifying power gear is decreased gradually to a Min-level humidifying power gear set in the OFF humidifying mode.

According to an embodiment of the invention, in an AUTO humidifying mode, a humidity threshold value is set between 0 and 100 using the IO interface, when the environmental humidity value H is lower than or equal to the humidity threshold value, the humidifying power gear is increased gradually to the Max-level humidifying power gear set in the ON humidifying mode, when the environmental humidity value H is greater than the humidity threshold value, the humidifying power gear is decreased gradually to the Min-level humidifying power gear set in the OFF humidifying mode.

According to an embodiment of the invention, in a TIMER humidifying mode, a countdown timer is set using the IO interface, wherein when the countdown time is not zero, the Max-level humidifying power gear is run, wherein when the countdown time reaches zero, the Min-level humidifying power gear is run.

According to an embodiment of the invention, in a CYCLE humidifying mode, an ON-time is set, and an OFF-time is set using the IO interface, wherein during the ON-time, the Max-level humidifying power gear is run, wherein during the OFF-time, the Min-level humidifying power gear is run.

According to an embodiment of the invention, a humidifying device enclosed in an enclosure for an indoor residential cannabis cultivation environment, the humidifying device includes: a water tank with a bottom, a top cover, side enclosure walls and a longitudinal channel passing through the water tank, wherein the longitudinal channel has openings on the bottom and the top cover of the water tank; a base with side enclosure walls, wherein the water tank sits on the top of the base, within the opening of the longitudinal channel on the bottom of the water tank faces the base; a valve on the bottom of the water tank to control flowing of water into the base from the water tank above the base; a water level buoy located inside the base, wherein the water level buoy is mechanically connected to the valve through a lever, wherein the valve is opened or closed by the water level buoy through the lever when water level in the base drops or rises; a movable flap in the top cover of the water tank; a bottom cover of the base; a control panel with a display screen mounted on a side enclosure wall of the base; a control module integrated into the control panel with a user IO interface for input and output of control information; an atomizer enclosed in the side enclosure walls of the base, wherein the atomizer is implemented for providing moisture in response to a humidifier control signal from the control module; a fan enclosed in the side enclosure walls of the base, wherein the fan is implemented for circulating moisture out of the base through the longitudinal channel passing through the water tank into the indoor residential cannabis cultivation environment in response to a fan control signal from the control module; and a temperature-humidity sensor outside the enclosure for sensing an environmental temperature value T and an environmental relative humidity value RH within the indoor cannabis cultivation environment.

According to an embodiment of the invention, the environmental temperature value T and the environmental relative humidity value RH are transmitted to the control module in real time, and a leaf VPD value is calculated from the environmental temperature value T and the environmental relative humidity value RH by the processing unit of the control module.

According to an embodiment of the invention, the humidifying device enclosed in an enclosure for an indoor residential cannabis cultivation environment further includes: a hose connected to the opening of the longitudinal channel on the top cover of the water tank for transiting moisture generated by the atomizer into the indoor residential cannabis cultivation environment, wherein the hose is connected to the opening of the longitudinal channel on the top cover of the water tank via a connector.

According to an embodiment of the invention, the humidifying device enclosed in an enclosure for an indoor residential cannabis cultivation environment of further includes: a ventilation hood, the ventilation hood is provided under the base, when the atomizer and the fan are started, external air enters the humidifier through the ventilation hood and enters the indoor cannabis growing environment through the hose.

According to an embodiment of the invention, the humidifying device enclosed in an enclosure for an indoor residential cannabis cultivation environment of further includes: a USB-C connector mounted on the rear cover of the enclosure for connecting an external controller to the control module in the enclosure for additional controls.

According to an embodiment of the invention, the humidifying device enclosed in an enclosure for an indoor residential cannabis cultivation environment of further includes: an audio headphone jack mounted on the rear cover of the enclosure for connecting to the temperature-humidity sensor outside the enclosure.

According to an embodiment of the invention, the atomizer is controlled by comparing the leaf VPD value with a predetermined threshold VPD value to optimize cannabis cultivation in the indoor residential cannabis cultivation environment.

According to an embodiment of the invention, the humidifying device enclosed in an enclosure for an indoor residential cannabis cultivation environment of further includes: a filter on the valve on the bottom of the water tank to filters the debris in the water to prevent clogging.

### BRIEF DESCRIPTION OF THE FIGURES

The invention will now be explained in more detail using exemplary embodiments and with references to the drawings, in which:

FIG. 1 is an exploded view of the humidifying device with VPD control, according to an embodiment of the invention.

FIG. 2 is a front view and a rear view of a part of the humidifying device with VPD control, according to an embodiment of the invention.

FIG. 3 is another view of the humidifying device with VPD control, according to an embodiment of the invention.

FIG. 4 is a cross-sectional view of the humidifying device with VPD control, according to an embodiment of the invention.

FIG. 5 is another perspective view of a part of the humidifying device with VPD control, according to an embodiment of the invention.

FIG. 6 is another cross-sectional view of the humidifying device with VPD control, according to an embodiment of the invention.

FIG. 7 is a chart illustrating the relationship among VPD, temperature and relative humidity in cannabis cultivation, according to an embodiment of the invention.

FIG. 8 is flowchart of the humidifying method with VPD control in humidifying mode, according to an embodiment of the invention.

FIG. 9 is a flowchart of the equipment error warnings of a humidifying device with VPD control, according to an embodiment of the invention.

FIG. 10 is a functional block diagram of humidifying device with VPD control, according to an embodiment of the invention.

### DETAILED DESCRIPTION OF PREFERRED EMBODIMENTS

The invention is susceptible of many embodiments. Preferred embodiments are illustrated in the attached figures and explained below. Minor variations of the preferred embodiments are evident in the figures, but are substantially the same, with common or similar components and the same reference numbers, except as noted.

The saturation vapor pressure deficit of an air sample (sometimes “vapor pressure deficit, VPD” or just “saturation deficit” for short) is the difference between the saturation vapor pressure and the actual vapor pressure at temperature T, i.e., SVP (Saturation Vapor Pressure)—AVP (Actual Vapor Pressure). VPD is the difference between moisture that is currently in the air and how much moisture the air can hold at saturation, or dew point under certain conditions. In ecological problems, VPD is often regarded as a measure of the “drying power” of air, because it plays an important part in determining the relative rates of growth and transpiration in plants. In micrometeorology, the vertical gradient of saturation deficit is a measure of the lack of equilibrium between a wet surface and the air passing over it. Vapor Pressure Deficit (“VPD”) plays a crucial role in plant indoor cultivation, especially high valued plants, such as cannabis.

Air VPD can be calculated from relative air humidity RH and temperature T. By definition, air VPD=SVP (Saturation Vapor Pressure)−AVP (Actual Vapor Pressure), SVP is the “Saturation Vapor Pressure” and AVP is the “Actual Vapor Pressure”.
a.

$$S V P = 6 10.78 {e}^{17.269 \frac{T}{237.3 + T}} ,$$

wherein, 610.78, 17.2694 and 237.3 are constants, and T is temperature of the air in degrees Celsius.
b.

$$A V P = 61 0.78 {e}^{17.2694 \frac{T}{237.3 + T}} \frac{R H}{100} ,$$

wherein, RH is the relative humidity of air in % unit, and 610.78, 17.2694 and 237.3 are constants, T is temperature of the air in degrees Celsius.
c.

$$Air V P D = S V P - A V P = 61 0.78 {e}^{17.2694 \frac{T}{237.3 + T}} ( 1 - \frac{R H}{100} ) ,$$

wherein, VPD unit is in Pa, T is temperature of the air in degrees Celsius. RH is the relative humidity of air in % unit, e≈2.71828.

The SVP value can be calculated by, for example, the following code:

| | |
|---|---|
| 0 | /*******************YPD**************************, |
| 1 | double get_svp (double t) |
| 2 | { |
| 3 | double svp, power; |
| 4 | |
| 5 | power = t / (t [symbol] [symbol] 37. [symbol] ) [symbol] |
| 6 | |
| 7 | svp = 610.78 [symbol] pow(2.71828, power) ; |
| 8 | |
| 9 | return svp; |
| 0 | } |

[symbol]

indicates data missing or illegible when filed

The code shows the calculation of the saturated vapor pressure SVP (Saturation Vapor Pressure) from a temperature of the air T. The unit is Pa. On the display, it is possible to display either Pa or kPa, or other units if appropriate.

According to another embodiment of the invention, the VPD can be calculated by following the steps below:
a. Obtaining real time air temperature T (° C.) and real time relative humidity RH, obtaining Leaf Offset, which is defaulted to zero and can be set by the user within the recommended range: −10° C. ˜10° C.;
b. Calculating the leaf temperature Leaf T=T+Leaf Offset, wherein T (° C.) is real time air temperature, Leaf T (° C.) is leaf temperature, Leaf Offset is the difference between the leaf and the air temperature, Leaf Offset=Leaf T−Air T;
c. Calculating ASVP, which is the air SVP, wherein ASVP=610.78×e\hat{ }(T/(T+237.3)×17.2694);
d. Calculating LSVP, which is the leaf SVP, wherein LSVP=610.78×e\hat{ }((T+Leaf Offset)/(T+Leaf Offset+237.3)×17.2694);
e. Calculating leaf VPD, wherein Leaf VPD=LSVP−(ASVP×RH/100);
f. Calculating real time Leaf VPD, wherein Leaf VPD=LSVP−ASVP×RH/100=610.78×e\hat{ }((T+Leaf Offset)/(T+Leaf Offset+237.3)×17.2694)−610.78×(e\hat{ }(T/(T+237.3)×17.2694))×RH/100, wherein the unit of Leaf VPD is Pa, the unit of temperature is ° C., the unit of RH is %, and e≈2.71828.
   The default value of Leaf Offset is 0, which means that T+Leaf Offset=T in the above equations, and the default value of the leaf VPD is equal to air VPD, i.e., under the default condition, Leaf VPD=610.78×e\hat{ }(T/(T+237.3)×17.2694)×(1−RH/100).

VPD plays an important role in cannabis cultivation. Plants respond to changes in water availability in both their aerial and soil environments. The driving force of transpiration rate is the gradient in vapour pressure between the dry atmosphere and the wet interior of leaves, which is referred to as VPD as discussed above.

A high VPD indicates a hotter and drier environment, while a low VPD results from a cooler and more humid environment. Scientific studies have demonstrated that the cannabis is highly responsive to changes in VPD, and VPD has been identified as a critical factor influencing transpiration and stomatal conductance in crops including cannabis.

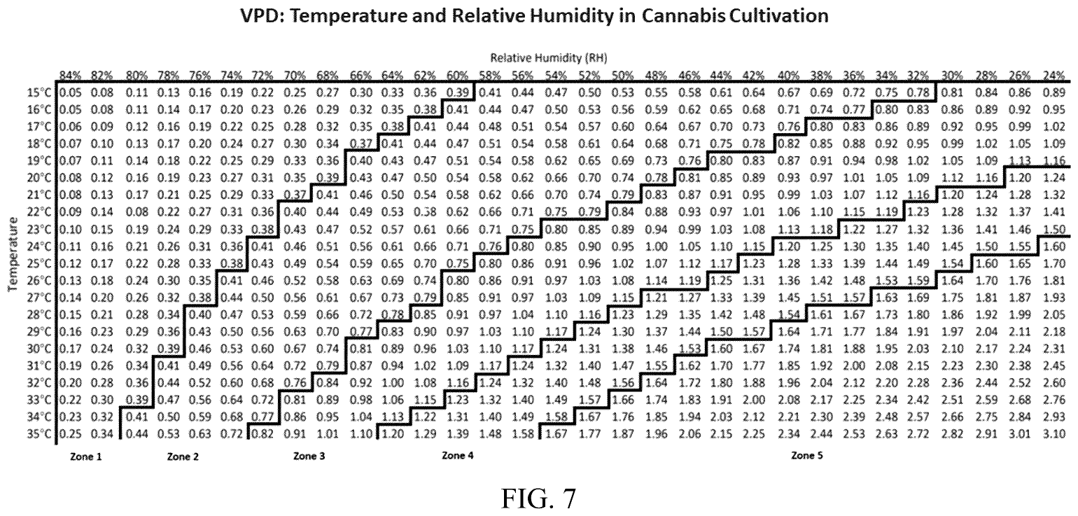

For cannabis growers with indoor grow tents or rooms with artificial lighting, in addition to temperature and relative humidity parameters, it is critical to take into consideration the importance of VPD and its impact on transpiration or nutrient uptake. For example, as illustrated in FIG. 7, in the chart depicting the relationship between temperature, humidity and VPD below, there are five zones: zone 1 through zone 5, with different combinations of temperature and relative humidity values. For example, zone 1: danger zone; zone 2: blue zone for low transpiration stage, propagation stage and early vegetative stage; zone 3: green zone for optimized healthy growth during transpiration stage, late vegetative state, and early flower stage; zone 4: yellow zone for high transpiration stage and late flower stage; zone 5: danger zone. Among these zones, zone 3 is the optimal zone with ideal combinations of temperature and relative humidity value for cannabis plants. For different stages, such as growth and flowering stages, temperature, relative humidity, and the recommended leaf VPD values are listed in the chart in FIG. 7.

Different VPD values are recommended for different stages of the plant. For example, for VPD value between 1.20 kPa and 1.60 kPa, which is considered relatively high, plants tend to open their stomata and release a considerable amount of water vapour into the environment to increase their transpiration. This increase in transpiration results in an increase in the plant's photosynthetic activity and will improve its overall growth during both growth and bloom. The optimal VPD range is between 0.80 kPa and 1.20 kPa. When the VPD is too high, the plant closes its stomata to avoid releasing excessive amount of the water vapor into the environment. Excessive transpiration causes dehydration. On the other hand, when VPD is too low, the atmosphere is already saturated and has reached the maximum water retention capacity, the plant will also close its stomata to avoid releasing too much water vapor into the atmosphere. Decreased transpiration reduces photosynthesis, slowing the plant's development and lowering yield.

There are two types of VPD's: air VPD and leaf VPD. Leaf VPD is what is been calculated in the present invention, which assumes that a leaf surface temperature is the same as the air temperature. This may not, however, always be the case due to external factors, such as light shining on a leaf causing it to heat up. According to the embodiment of the invention, there is an option in the humidifier settings to allow users to measure and input the leaf surface temperature in relation to the air temperature (leaf offset), which will change the Air VPD reading to an estimated leaf VPD reading.

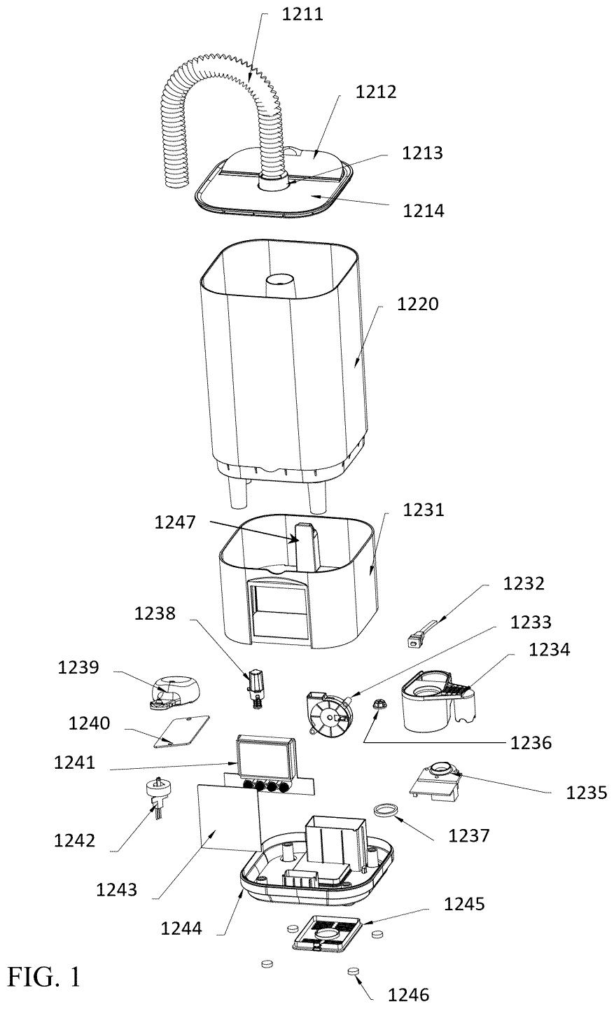

FIG. 1 is an exploded view of the humidifying device with VPD control, according to an embodiment of the invention. The humidifying device with VPD control, or the VPD-humidifier 1200 includes a water tank 1220 for holding water within it, the water tank 1220 can be many different configurations and shapes for holding water to be vaporized to control environmental humidity. The water tank 1220 sits on the top of a base 1231. On the top of the water tank 1220, a water tank lid 1214 covers the upper opening of the water tank 1220. One side of the water tank lid 1214 is a water tank lid movable flap 1212, which can be movable and opened to add water into the water tank 1220. Water in the water tank 1220 enters the base 1231 through a filter holder and valve head, or piston head 1238. The filter on the valve filters out possible impurities to prevent clogging of the valve and to ensure water quality in the base for proper atomization.

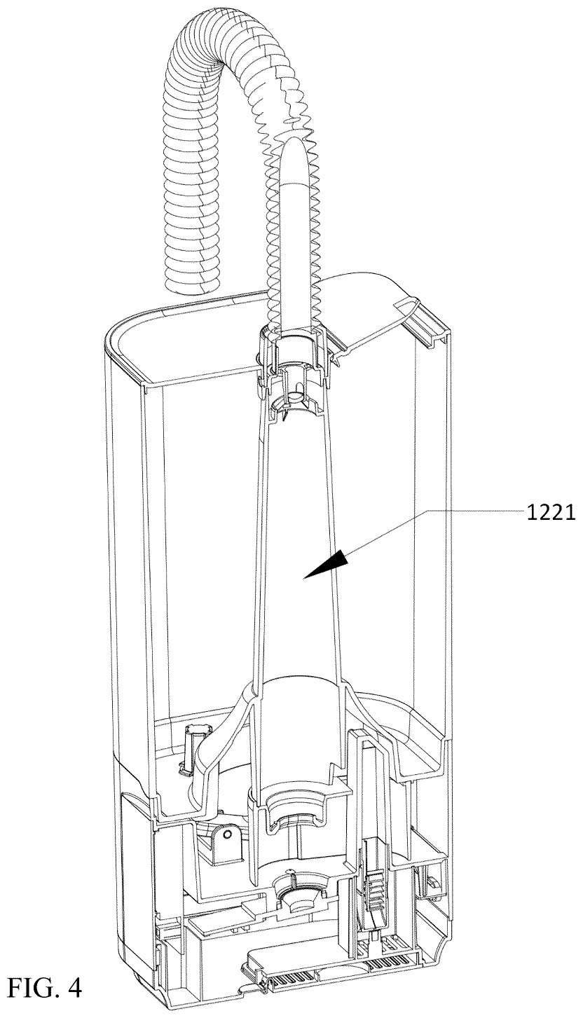

At the centre of the water tank lid 1214, a hose connector 1213 connects air duct hose 1211 to transport water vapor atomized inside the water tank 1220 out into the indoor cannabis cultivating environment to adjust the humidity level in the indoor cannabis cultivating environment. Water vapor is produced by atomizing water in the base 1231 using atomizing components 1235, which can be, for example, ultrasonic atomizers. The atomizing components 1235 are adjacent to a fan 1233 and an airduct connector 1234 to fan out the water vapor into the indoor cannabis cultivating environment through proper channels and hoses. The atomization channel 1221 is located in the centre of the water tank and above the atomizing components 1235 to directly channel water vapor produced by the atomizing components 1235 into the air duct hose 1211, then into the indoor cannabis cultivating environment. The atomization channel 1221 can be better viewed in FIG. 4, which is a cross-sectional view of the humidifying device with VPD control.

The electronic control of the VPD-humidifier 1200 includes a PCB board 1240 and a main board 1241, both contain control circuits. The main board 1241 can include a display screen and control buttons for information input and output. The display screen can be, for example, a touch screen which can function as a display screen and at the same time as an input-output device. Various control information can be displayed on the display screen, which includes, for example, temperature, humidity, VPD value, humidifying gears, etc. The screen of the main board 1241 is protected by, for example, a piece of tempered glass 1243. A water level buoy 1239 floats with the water level inside the base 1231, when the water level is low in the base 1231, the water level buoy 1239 lifts the valve head, or piston head 1238 with the water level buoy's own weight through a lever, causing water entering into the base 1231 from the water tank 1220. On the other hand, when the water level is high in the base 1231, the water level buoy 1239 floats upward, pushing down the valve head, or piston head 1238 through the lever, preventing water from entering the base 1231 from the water tank 1220. A Hall device 1242 is implemented to monitor the water level within the base 1231, when the water level in the base 1231 is too low, a low water level warning signal is produced. The VPD-humidifier 1200 includes a temperature and humidity sensor for sensing and monitoring temperature and humidity in the indoor cannabis cultivation environment. The VPD-humidifier 1200 further includes, for example, wires 1232, bottom cover 1244, a ventilation hood 1245, foot pads 1246, a lock 1236, a silicon ring 1237, and an air outlet 1247, which will be discussed in more details in the following figures with different views and corresponding paragraphs.

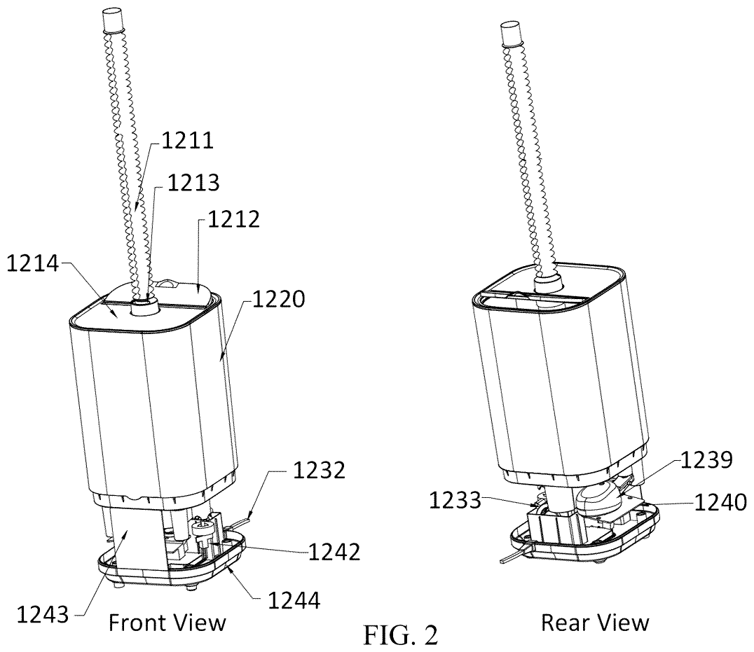

FIG. 2 is a front view and a rear view of a part of the humidifying device with VPD control, according to an embodiment of the invention. In the front view of the VPD humidifier 1200, the walls of the base 1231 are removed to show detailed structure inside the base 1231. In the front view, the Hall device 1242 is illustrated inside the base 1231. As discussed above, the Hall device 1242 is implemented to monitor the water level inside the base 1231. In the corresponding rear view, the fan 1233, the water level buoy 1239, and the PCB board 1240 are illustrated inside the base 1231. In both the front view and the rear view, the following components are correspondingly illustrated: the air duct hose 1211, the water tank lid movable flap 1212, the hose connector 1213, the water tank lid 1214, and the water tank 1220.

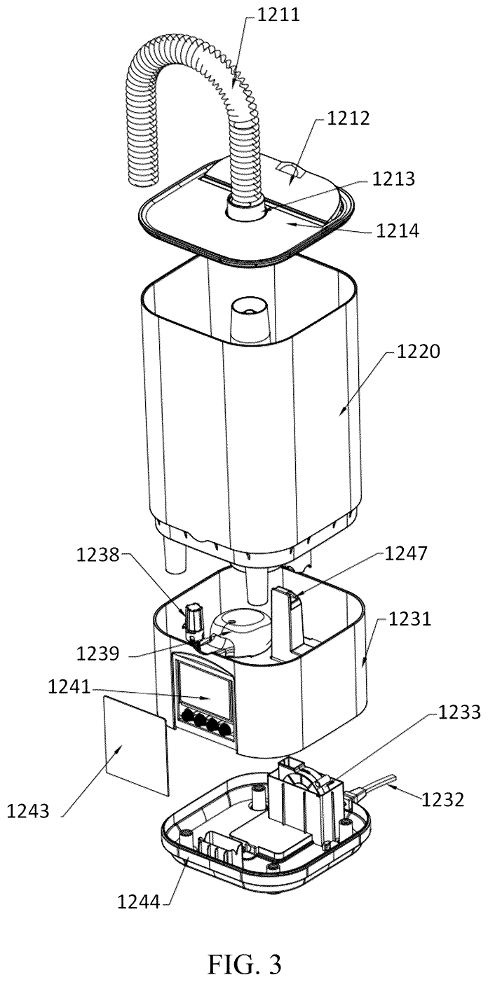

FIG. 3 is another view of the humidifying device with VPD control, according to an embodiment of the invention. In this view, more components inside the base 1231 are illustrated, for example, the filter holder and valve head, or piston head 1238 and the water level buoy 1239 are positioned adjacent to each other inside the base 1231 of the VPD humidifier 1200. Under the rotation of the fan 1233, the external air enters the ventilation hood 1245 and enters the atomization space through the outlet 1247. Under the flow of air, the water mist is brought into the atomization channel 1221 and finally enters the indoor cannabis cultivation environment through the air duct hose 1211 to adjust the humidity.

FIG. 4 is a cross-sectional view of the humidifying device with VPD control, according to an embodiment of the invention. This cross-sectional view of the VPD humidifier shows the atomization channel 1221 passing through the middle of the water tank 1220 and transporting water vapor through the air duct hose 1211 into the indoor cannabis cultivation environment.

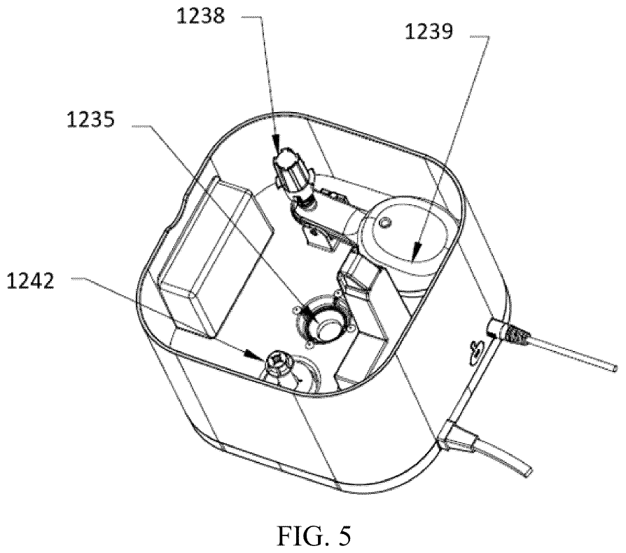

FIG. 5 is another perspective view of a part of the humidifying device with VPD control, according to an embodiment of the invention. In this close-up view, more details inside the base 1231 are illustrated, for example, the filter holder and valve head, or piston head 1238 and the water level buoy 1239 are positioned adjacent to each other inside the base 1231 of the VPD humidifier 1200, so that the water level buoy 1239 can act on the valve head, or piston head 1238 through a level connecting them. In addition, the atomizing components 1235 and the Hall device 1242 are illustrated inside the base 1231 with more details.

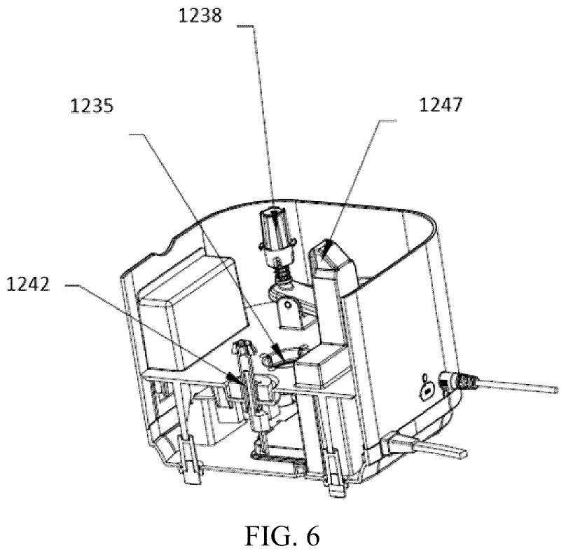

FIG. 6 is another cross-sectional view of the humidifying device with VPD control, according to an embodiment of the invention. In this view, more details are shown inside the base 1231. For example, the Hall device 1242 is fixed on the base, the atomizing components 1235 is located in the middle of the base 1231.

According to an embodiment of the invention, the power of the humidifier includes 10 levels, or called gears. According to an embodiment of the invention, the humidifying device with VPD control has only a humidifying mode and there is no fan mode, instead, the fan is defaulted to full speed. The humidifying gears are also the power gears of the ultrasonic atomizer. The humidifying gears are detailed in the table below, with fan at default full speed gear-10:

| | Corresponding | |
|---|---|---|
| Humidifier | Humidifier | Fan Duty |
| Gear | Duty Cycle (%) | Cycle (%) |
| Gear-0 | 0 | 0 |
| Gear-1 | 56 | 100 |
| Gear-2 | 60 | 100 |
| Gear-3 | 64 | 100 |
| Gear-4 | 68 | 100 |
| Gear-5 | 73 | 100 |
| Gear-6 | 78 | 100 |
| Gear-7 | 83 | 100 |
| Gear-8 | 88 | 100 |
| Gear-9 | 93 | 100 |
| Gear-10 | 100.0 | 100 |

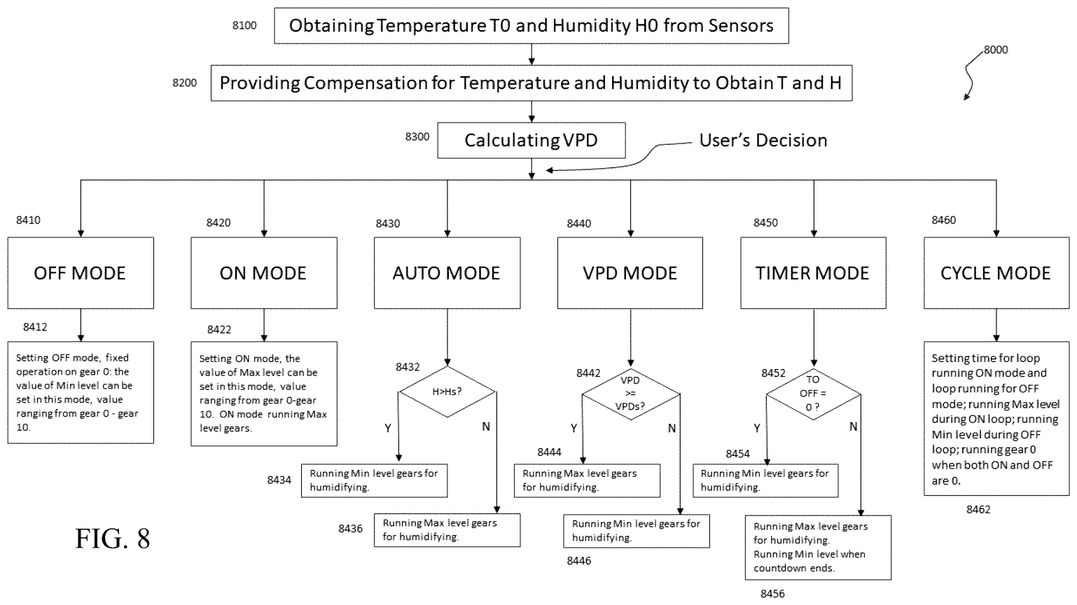

FIG. 8 is flowchart of the VPD control method in humidifying mode, according to an embodiment of the invention. The VPD control method 8000 includes a first step 8100, obtaining a temperature T₀ and a humidity H₀ from sensors. According to the embodiments discussed above, temperature sensors and humidity sensor are deployed inside the indoor growing tent or room with artificial lighting. These temperature sensors and humidity sensors are connected to the control unit in which the temperature and humidity values are received and used to calculate VPD. The second step 8200 is: providing compensation for temperature and humidity to obtain temperature T and relative humidity RH. Then at the third step 8300, calculating VPD using T and RH values. A decision is made to determine which mode to run selected from a plurality of humidifying modes.

According to an embodiment of the invention, there are, for example, six humidifying modes: OFF mode, ON mode, AUTO mode, VPD mode, TIMER mode and CYCLE mode.
a. The first mode 8410 is OFF mode, in which the step 8412 is performed: setting OFF mode, default humidifying setting is gear-0, the device is not running. The value of Min level humidifying power can be set in this mode, value ranging from gear-0 to gear-10. Min level humidifying power is the customized minimum humidifying power level in a humidifying mode.
b. The second mode 8420 is ON mode, in which the step 8422 is performed: setting ON mode, the default humidifying gear is 6. The value of Max level humidifying power can be set in this mode, value ranging from gear 0 to gear 10. ON mode runs the Max level humidifying power gear. Max level humidifying power is the customized maximum humidifying power level in a humidifying mode.
c. The third mode 8430 is AUTO mode, the default setting is OFF, in which humidity H is compared to a predetermined humidity value Hₛ at step 8432. Humidity can be set and changed cyclically from 0 to 100 by pressing the INCREASE/DECRESE buttons. When a predetermined humidity value Hₛ is set, if the humidity reading H from the sensor is lower than or equal to predetermined humidity value, step 8436 is performed, ON mode is trigged and the humidifying gear gradually increases to the Max level humidifying power under ON mode. On the other hand, if the humidity reading H from the sensor is higher than the predetermined value Hₛ, step 8434 is performed, OFF mode is triggered, and the humidifying gear decreases gradually to the Min level humidifying power under OFF mode.
d. The fourth mode is VPD mode 8440, in which VPD is compared to a predetermined VPDₛ. VPD value can be set and changed cyclically from 0.0 kPa to 3.0 kPa by pressing the INCREASE/DECRESE buttons. After setting the VPDₛ value, the VDP value calculated from the sensor readings is compared to the predetermined VPDₛ. If VPD is greater than or equal to VPDₛ, step 8444 is performed: ON mode is triggered and humidifying gear is gradually increases to the Max level humidifying power under ON mode. Otherwise, if VPD<VPDₛ, step 8446 is performed: OFF mode is triggered, and the humidifying gear decreases gradually to the Min level humidifying power under OFF mode.
e. The fifth mode is TIMER mode 8450, in which a TIMER is set and tracked, when the TIMER is not zero, perform step 8456: running Max level humidifying power gear; when TIMER reaches 0, perform step 8454: running Min level humidifying power gear; if TIMER is set to 0, continue to run Min level humidifying power. The TIMER default value is 0:00.
f. The last mode 8460 is CYCLE mode, in which step 8462 is performed: setting ON-time for loop running ON mode and OFF-time for loop running for OFF mode; running Max level humidifying power during ON loop; running Min level humidifying power during OFF loop; running gear 0 when both ON-time and OFF-time are 0. The default ON-time and OFF-time are both 0:00. According to an embodiment of the invention, the user can choose gear-2 as the minimum level gear, and gear-7 as the maximum level gear. In AUTO mode, the humidifier runs gear-2 for humidifying when the humidity is detected to be higher than the set humidity, and gear-7 for humidifying when it is lower than the predetermined humidity threshold. Similarly, in VPD mode, TIMER mode and Cycle mode, the humidifier can run gear-2 and gear-7 as Min level humidifying power and Max level humidifying power correspondingly as well.

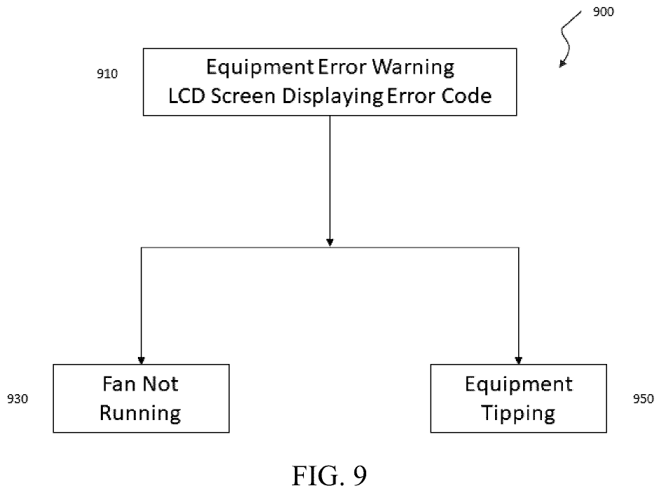

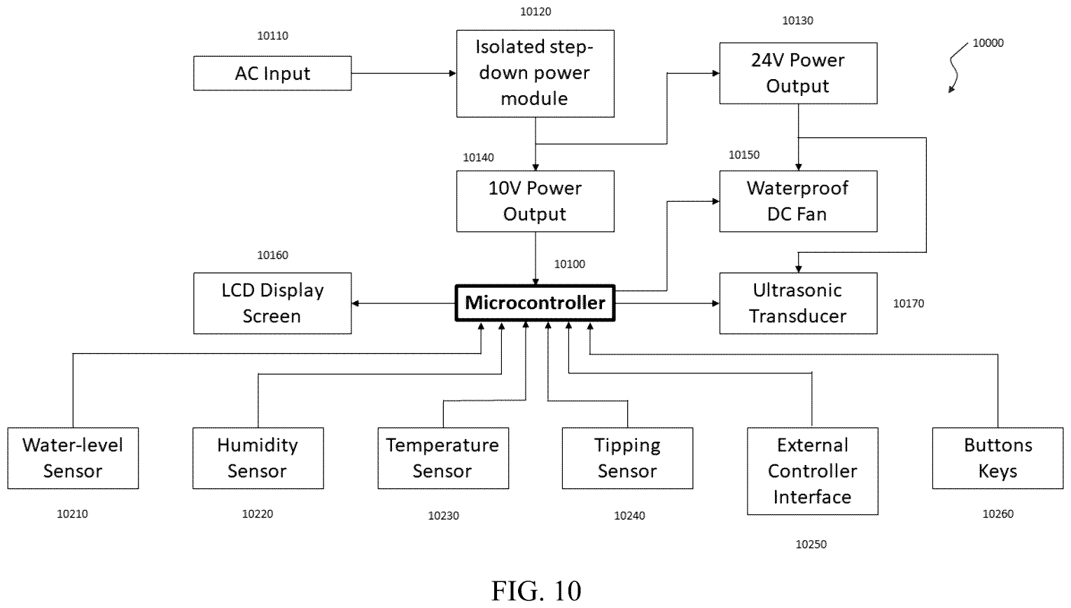

FIG. 9 is a flowchart of the equipment error warnings of a humidifying device with VPD control, according to an embodiment of the invention. The equipment error warning mechanism 900 includes at least two warning codes, the equipment error warning 910 is caused by, for example, warning code 930 is fan not running warning, and warning code 950 is equipment tipping warning. When any one of the errors happens, the error is reported to the equipment error warning mechanism 910, which displays the corresponding error message(s) on the LCD screen on the front cover. Further details regarding the fan control and the tipping sensor will be discussed in FIG. 10 and corresponding paragraphs below.

FIG. 10 is a functional block diagram of a humidifying device with VPD control, according to an embodiment of the invention. A humidifying device with VPD control 10000 includes many functional modules as illustrated in FIG. 10. All of the functional modules of the humidifying device with VPD control 10000 are connected to a microcontroller 10100 which functions as a central processing unit for processing all information and controlling all functional modules. According to an embodiment of the invention, the microcontroller is the processing unit of the control module, the microcontroller can also be a minicomputer, a logic device, a programable logic circuit, a PCBA (printed circuit board assembly), a Field Programmable Gate Array (FPGA), or the equivalents. The entire humidifying device with VPD control 10000 is powered by an AC input 10110 which provide power to an isolated step-down power module 10120 to convert the AC power into appropriate DC powers to corresponding modules. For example, the isolated step-down power module 10120 provides an output to the 10V Power Output module 10140 which directly powers the microcontroller 10100. The isolated step-down power module 10120 also provides an output to the 24V Power Output module 10130, which powers the water-proof DC fan 10150, and the ultrasonic transducer 10170. The ultrasonic transducer 10170 converts electrical energy into ultrasonic energy to atomize water into vapor. Both the water-proof DC fan 10150 and the ultrasonic transducer 10170 are connected to and controlled by the microcontroller 10100 with appropriate control signals.

The humidifying device with VPD control 10000 includes many sensors for providing real time environmental information to the microcontroller 10100. These sensors include, for example, a water level sensor 10210 for monitoring water level in the water tank of the humidifying device with VPD control 10000, a humidity sensor 10220 for monitoring humidity in the indoor residential cannabis cultivation environment, a temperature sensor 10230 for monitoring the corresponding temperature in the indoor residential cannabis cultivation environment, and a tipping sensor 10240 for monitoring the posture of the entire humidifying device and providing warning signals in case a tipping is happening. The humidifying device with VPD control 10000 also includes an LCD display screen 10160 connected to the microcontroller 10100 for displaying information, a plurality of keys and buttons 10260 for input information and setting up the modules, and an external controller interface 10250 for connecting to an external proprietary controller (not shown in the figure) manufactured by the inventor of the present invention. The external proprietary controller can control the humidifying device and conduct software upgrade. The keys and buttons 10260 can be physical key and buttons, meanwhile they can also be keys and buttons on a touch screen.

Overall, the VPD humidifier, or humidifying device with VPD control, is powered by a 10V DC power supply, which is DC-to-DC converted into 5V and 3.3V for power different components of the VPD humidifier. Information display is achieved by the LCD screen. Information input is achieved either by a set of four physical keys, or a touch screen. Two external connectors are implemented, one is a Type-C USB connector to connect to a proprietary external controller specifically designed by the inventor to conduct proprietary tasks such as firmware/software update of the control system. The other connector is an audio jack connector to connect to the external temperature and humidity sensors. Water level is monitored by a corresponding water level sensor. Upon receiving environmental information from the sensors, the controller of the VPD humidifier transmits corresponding control signals to control the ultrasonic atomizer and the fan. The fan speed is defaulted to full speed in the humidifying mode, and power of the ultrasonic atomizer is adjusted by a PWM signal to control the power level of the atomizer, thus the power level of the VPD humidifier.

When the power of the VPD humidifier is turned on, the system starts functioning. The main controller, or the microcontroller, is initiated, the LCD back light is turned on, and the LCD screen is turned on. After initiation, temperature and humidity sensors data are read displayed on the LCD screen, anti-tipping sensor data is read, water level sensor data is read, when there is warning signal, the corresponding warning signal is displayed on the LCD screen. Then the time signal is read on the RTC circuit, the count-down timer is displayed on the LCD in a corresponding mode. The buzzer buzzes when the keys are touched, and the LCD screen displays corresponding work mode or power mode, working conditions and warning status, if any. The ultrasonic atomizer atomizes water in the base into vapor through high frequency ultrasound, at the same time, the fan is turned on to blow the vapor and moisturized air into the indoor cannabis cultivation environment to adjust environment humidity. The water level sensor monitors the water level in the base to prevent dry burning of the ultrasonic atomizer when the water level is too low. When the water level is too low, a warning signal is transmitted to the controller, which in turn transmits a control signal to stop the atomizer to prevent damage. The humidifying power gears are set by keys or the touch screen, the controller transmits corresponding PWM signals to the ultrasonic atomizer and the fan to control the humidifying power level.

The humidifying device with VPD control as discussed above is a specialty device which has not previously been invented specifically for indoor cannabis cultivation, no humidifier or similar humidifier with controller as discussed above is on the market as of the day of the filing of this patent application. There exists long-felt market need. The humidifying device with VPD control as discussed above requires unconventional sensor choices, specialty programming, and modifications to a humidifier's design to allow it to be integrated into a residential indoor cannabis cultivation space. This long-felt specialty market need is not fulfilled so far by any other designs on the market.

The humidifying device with VPD control as discussed above requires a redesign of the conventional humidifier to accept not only the humidity sensor readings, but in addition, it requires it to be able to compute these humidity sensor readings along with the temperature sensor readings to provide an air VPD value. The humidifier needs to be reprogrammed to be controllable based on the VPD readings instead of just temperature, which is completely novel to the indoor cannabis cultivation humidifier market. The hardware, firmware, and software all need to be redesigned and redeveloped to accomplish the humidifying device with VPD control as discussed above, which can also be called a VPD humidifier for indoor cannabis cultivation, or a humidifying device with VPD control for indoor cannabis cultivation. The present invention includes several additional unique hardware features added to this specific VPD humidifier, such as the external sensors, expandable tubing, and air intake fan controls, etc., which are all specifically developed to cater to the indoor residential cannabis cultivation market.

Controlling the environment via VPD that only caters to a specific consumer market, such as the indoor residential cannabis cultivation market, is relatively new. The high cost of setting up an indoor residential cannabis cultivation room or tent has long prevented the market from developing any specialty devices until recently, with the introduction of legalized residential indoor cannabis cultivation across the nation. When combined with the high cost of legally purchasing cannabis, this has led to the rise of consumers looking to start their own residential indoor cannabis cultivation. Financially, with each plant grown having a market value of on average $200-$1000, residential growers are now willing to spend much more on specialty indoor grow devices to improve their plant quality as they can often recapture the cost of expensive indoor cultivation equipment within 3-6 months. This has led to a push for better indoor cultivation equipment to be developed.

The present invention is more focused on the indoor residential cultivation market because commercial indoor growers are still using temperature and humidity devices to fine tune their grow environment in lieu of VPD, but residential growers often lacking the tools needed to maintain both a set temperature and humidity, which would require a humidifier, a dehumidifier, an air conditioner, and a humidifier. By utilizing VPD, residential growers can eliminate at least one or two of these equipment's while still maintaining the same optimal cultivation environment as long as the temperature and humidity of the cultivation space does not reach extreme levels.

Other and various embodiments within the scope of the invention will be readily evident to practitioners skilled in the art, from specification, figures and claims that follow.

What is claimed is:

1. A humidifying device with VPD control for indoor residential cannabis cultivation, the humidifying device with VPD control comprising:
a control module with a processing unit, a display screen and an IO interface;
a humidifier for providing moisture in response to a humidifier control signal from the control module;
a fan for circulating moisture in response to a fan control signal from the control module; and
a temperature-humidity sensor for sensing an environmental temperature value T and an environmental relative humidity value RH within an indoor cannabis cultivation environment,
wherein the environmental temperature value T and the environmental relative humidity value RH are transmitted to the control module in real time, and
wherein a leaf VPD value is calculated from the environmental temperature value T and the environmental relative humidity value RH by the processing unit of the control module.

2. The humidifying device with VPD control for indoor residential cannabis cultivation of claim 1,
wherein the leaf VPD value is compared with a pre-determined VPD threshold value to determine running modes of the humidifier to control the leaf VPD value within the indoor cannabis cultivation environment, and
wherein the control module transmits the humidifier control signal to the humidifier to adjust the environmental temperature value T and the environmental relative humidity value RH within the indoor cannabis cultivation environment.

3. The humidifying device with VPD control for indoor residential cannabis cultivation of claim 2,
wherein the temperature-humidity sensor senses an updated environmental temperature value T and an updated environmental relative humidity value RH within the indoor cannabis cultivation environment;
wherein the updated environmental temperature value T and the updated environmental relative humidity value RH are transmitted to the control module; and
wherein an updated leaf VPD value is calculated from the updated environmental temperature value T and the updated environmental relative humidity value RH by the processing unit of the control module.

4. The humidifying device with VPD control for indoor residential cannabis cultivation of claim 3,
wherein the updated leaf VPD value is compared with the pre-determined VPD threshold value again to adjust the running modes of the humidifier to control the leaf VPD within the indoor cannabis cultivation environment; and
wherein the control module transmits the humidifier control signal to the humidifier to adjust the environmental temperature value T and the environmental relative humidity value RH within the indoor cannabis cultivation environment.

5. A humidifying device with VPD control for indoor residential cannabis cultivation, the humidifying device with VPD control comprising:
a power unit for providing electric power to the humidifying device with VPD control for indoor residential cannabis cultivation;
a DC fan driven by a DC motor;
a humidifier for providing moisture to the humidifying device with VPD control for indoor residential cannabis cultivation, wherein the humidifier includes a plurality of humidifying power gears under a humidifying mode;
an IO interface for input and output of control information and status information;
a temperature-humidity sensor for sensing an environmental temperature value T and an environmental relative humidity value RH within an indoor cannabis cultivation environment, wherein a leaf VPD value is calculated from the environmental temperature value T and the environmental relative humidity value RH; and
a main control unit for communicating with and controlling the power unit, the DC fan, the DC motor, the humidifier, the IO interface, and the temperature-humidity sensor, wherein, in a VPD humidifying mode of the humidifying device with VPD control, the leaf VPD value calculated from the environmental temperature value T and the environmental relative humidity value RH is implemented to control the humidifying device with VPD control for indoor residential cannabis cultivation.

6. The humidifying device with VPD control for indoor residential cannabis cultivation of claim 5, wherein the leaf VDP is calculated from the environmental temperature value T and the environmental relative humidity value RH by:
$$Leaf VPD = 6 10.78 {e}^{17.2694 \frac{T + Leaf offset}{237.3 + T + Leaf offset}} - 6 10.78 {e}^{17 \text{.2694} \frac{T}{237.3 + T}} \times \frac{R H}{100} ,$$
wherein, VPD unit is in Pa, T is temperature of the air in degrees Celsius, RH is relative humidity of air in % unit and e≈2.71828.

7. The humidifying device with VPD control for indoor residential cannabis cultivation of claim 6, wherein when the Leaf Offset is defaulted to 0° C., the leaf VPD value is calculated from the environmental temperature value T and the environmental relative humidity value RH via:
$$Leaf VPD = 6 10.78 {e}^{17.2694 \frac{T}{237.3 + T}} ( 1 - \frac{R H}{100} ) ,$$
wherein, Leaf VPD unit is in Pa, T is temperature of the air in degrees Celsius, RH is relative humidity of air in % unit and e≈2.71828.

8. The humidifying device with VPD control for indoor residential cannabis cultivation of claim 6, wherein the user can set a Leaf Offset value between −10° C. and 10° C.

9. The humidifying device with VPD control for indoor residential cannabis cultivation of claim 7, wherein in an VPD humidifying mode, when the leaf VPD is greater than or equal to a predetermined threshold VPDₛ, the humidifying power gear is increased gradually to a Max-level humidifying power gear set in the ON humidifying mode, wherein when the leaf VPD is lower than the predetermined threshold VPDₛ, the humidifying power gear is decreased gradually to a Min-level humidifying power gear set in the OFF humidifying mode.

10. The humidifying device with VPD control for indoor residential cannabis cultivation of claim 7, wherein in an AUTO humidifying mode, a humidity threshold value is set between 0 and 100 using the IO interface, when the environmental humidity value H is lower than or equal to the humidity threshold value, the humidifying power gear is increased gradually to the Max-level humidifying power gear set in the ON humidifying mode, when the environmental humidity value H is greater than the humidity threshold value, the humidifying power gear is decreased gradually to the Min-level humidifying power gear set in the OFF humidifying mode.

11. The humidifying device with VPD control for indoor residential cannabis cultivation of claim 7, wherein in a TIMER humidifying mode, a countdown timer is set using the IO interface, wherein when the countdown time is not zero, the Max-level humidifying power gear is run, wherein when the countdown time reaches zero, the Min-level humidifying power gear is run.

12. The humidifying device with VPD control for indoor residential cannabis cultivation of claim 7, wherein in a CYCLE humidifying mode, an ON-time is set, and an OFF-time is set using the IO interface, wherein during the ON-time, the Max-level humidifying power gear is run, wherein during the OFF-time, the Min-level humidifying power gear is run.

13. A humidifying device enclosed in an enclosure for an indoor residential cannabis cultivation environment, the humidifying device comprising:
a water tank with a bottom, a top cover, side enclosure walls and a longitudinal channel passing through the water tank, wherein the longitudinal channel has openings on the bottom and the top cover of the water tank;
a base with side enclosure walls, wherein the water tank sits on the top of the base, within the opening of the longitudinal channel on the bottom of the water tank faces the base;
a valve on the bottom of the water tank to control flowing of water into the base from the water tank above the base;
a water level buoy located inside the base, wherein the water level buoy is mechanically connected to the valve through a lever, wherein the valve is opened or closed by the water level buoy through the lever when water level in the base drops or rises;
a movable flap in the top cover of the water tank;
a bottom cover of the base;
a control panel with a display screen mounted on a side enclosure wall of the base;
a control module integrated into the control panel with a user IO interface for input and output of control information;
an atomizer enclosed in the side enclosure walls of the base, wherein the atomizer is implemented for providing moisture in response to a humidifier control signal from the control module;
a fan enclosed in the side enclosure walls of the base, wherein the fan is implemented for circulating moisture out of the base through the longitudinal channel passing through the water tank into the indoor residential cannabis cultivation environment in response to a fan control signal from the control module; and
a temperature-humidity sensor outside the enclosure for sensing an environmental temperature value T and an environmental relative humidity value RH within the indoor cannabis cultivation environment.

14. The humidifying device enclosed in an enclosure for an indoor residential cannabis cultivation environment of claim 13,
wherein the environmental temperature value T and the environmental relative humidity value RH are transmitted to the control module in real time, and
wherein a leaf VPD value is calculated from the environmental temperature value T and the environmental relative humidity value RH by the processing unit of the control module.

15. The humidifying device enclosed in an enclosure for an indoor residential cannabis cultivation environment of claim 13, further comprises:
a hose connected to the opening of the longitudinal channel on the top cover of the water tank for transiting moisture generated by the atomizer into the indoor residential cannabis cultivation environment, wherein the hose is connected to the opening of the longitudinal channel on the top cover of the water tank via a connector.

16. The humidifying device enclosed in an enclosure for an indoor residential cannabis cultivation environment of claim 13, further comprises:
a ventilation hood, wherein the ventilation hood is provided under the base, wherein when the atomizer and the fan are started, external air enters the humidifier through the ventilation hood and enters the indoor cannabis growing environment through the hose.

17. The humidifying device enclosed in an enclosure for an indoor residential cannabis cultivation environment of claim 13, further comprises:
a USB-C connector mounted on the rear cover of the enclosure for connecting an external controller to the control module in the enclosure for additional controls.

18. The humidifying device enclosed in an enclosure for an indoor residential cannabis cultivation environment of claim 13, further comprises:
an audio headphone jack mounted on the rear cover of the enclosure for connecting to the temperature-humidity sensor outside the enclosure.

19. The humidifying device enclosed in an enclosure for an indoor residential cannabis cultivation environment of claim 13, wherein the atomizer is controlled by comparing the leaf VPD value with a predetermined threshold VPD value to optimize cannabis cultivation in the indoor residential cannabis cultivation environment.

20. The humidifying device enclosed in an enclosure for an indoor residential cannabis cultivation environment of claim 13, further comprises: a filter on the valve on the bottom of the water tank to ensure water quality in the base for proper atomization.
